(19) United States
(12) Patent Application Publication
(10) Pub. No.: US 2017/0075894 A1
(43) Pub. Date: Mar. 16, 2017

(54) Contacts Confidence Scoring

(71) Applicant: Facebook, Inc., Menlo Park, CA (US)

(72) Inventors: Sumitha Poornachandran, Sunnyvale, CA (US); Margaryta Skrypachova, Los Altos Hills, CA (US); Fernando Jorge de Almeida da Silva, Dublin (IE); Benjamin Leon Grol-Prokopczyk, San Francisco, CA (US); Sanghyeon Park, Oakland, CA (US); Matthew Lyle Bruce, Alameda, CA (US)

(21) Appl. No.: 14/854,690

(22) Filed: Sep. 15, 2015

(51) Int. Cl. G06F 17/30

(52) U.S. Cl. CPC G06F 17/3053; G06F 17/30867

(57) ABSTRACT

In one embodiment, a method includes receiving, from a client system of a first user of an online social network, an unique identifier associated with a second user of the online social network, the unique identifier being sent responsive to a communication between the second user and the first user, accessing a social graph including first and second nodes corresponding to the first and second users, respectively, identifying the second user based on the unique identifier, retrieving profile information associated with the second user and a privacy setting associated with the second user, determining whether the information is visible to the first user based on the privacy setting and a degree of separation in the social graph between the first node and the second node, and sending, to the client system, the profile information that is visible to the first user for display in association with the communication.

### TECHNICAL FIELD

This disclosure generally relates to confidence scoring for contacts.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g., wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

Social-graph analysis views social relationships in terms of network theory consisting of nodes and edges. Nodes represent the individual actors within the networks, and edges represent the relationships between the actors. The resulting graph-based structures are often very complex. There can be many types of nodes and many types of edges for connecting nodes. In its simplest form, a social graph is a map of all of the relevant edges between all the nodes being studied.

A mobile computing device—such as a smartphone, tablet computer, or laptop computer—may include functionality for determining its location, direction, or orientation, such as a GPS receiver, compass, gyroscope, or accelerometer. Such a device may also include functionality for wireless communication, such as BLUETOOTH communication, near-field communication (NFC), or infrared (IR) communication or communication with a wireless local area networks (WLANs) or cellular-telephone network. Such a device may also include one or more cameras, scanners, touchscreens, microphones, or speakers. Mobile computing devices may also execute software applications, such as games, web browsers, or social-networking applications. With social-networking applications, users may connect, communicate, and share information with other users in their social networks.

### SUMMARY OF PARTICULAR EMBODIMENTS

Social-networking systems often require one or more forms of valid contact information for each user in order to notify users of security violations, verify account status or activity, or communicate other critical information to users. However, due to the increased use of disposable phones, prepaid Subscriber Identity Module (“SIM”) cards, and other similar communications technologies that enable users to switch phone numbers relatively quickly, maintaining up-to-date contact information for social-networking system users has become increasingly difficult. A different aspect of social-networking systems allow users to associate contact information stored on various devices, applications, or services, such as internet-based mail and calendar applications, with a social-networking system account to simplify contact management across accounts, integrate disparate sources of contact information in a central location, and enhance social-networking interactions and experiences. Particular embodiments of the present disclosure utilize imported contact data to assess the likelihood that the contact information on file for a particular user is up to date. Imported data from various users is abstracted to address privacy concerns and aggregated to validate or assess the validity of the contact information provided by users.

In certain embodiments, primary contact information for a user of a social-networking system is provided, for example, during an account registration process. A confidence score is generated that gauges the relative level of certainty with which the user is associated with the primary contact information. In this case the confidence score may initially be quite high. The confidence score can be expressed as a percentage, such as 100%; however, the confidence score can also be expressed in any suitable metric or fashion. The system receives information from various other users regarding updates to contact information, such as from a contacts list in a device or application. In general, the system uses these contact information updates to better assess the likelihood with which the user is still associated with the primary contact information that he/she provided and update the confidence score for the primary contact information accordingly. The system can take certain actions, such as sending an email or other notification requesting that the user validate the primary contact information, based on the confidence score meeting one or more conditions.

For example, a friend of the user uploads updated contact information for the user to a social-networking system. The system determines whether the updated contact information for the user is different from the primary contact information. If the new contact information is different from the primary contact information, then the system adjusts the confidence score to reflect uncertainty regarding whether the user is still associated with the primary contact information. Several users may submit similar updates regarding updated contact information for the user. In this case, the system may modify the confidence score to reflect a relatively low level of certainty regarding whether the user is still associated with the primary contact information. Once the confidence score falls below a certain threshold, other actions may be taken by the system involving verification and/or validation of the primary contact information for the user.

As another example, other users of the social networking system upload updated contact information to a social-networking system that associates a different user with the primary contact information that the user used to register with the social-networking system. The system determines that the different user is different from the original user who registered with the primary contact information, and adjusts the confidence score to reflect the uncertainty regarding the primary contact information introduced by these updates. In other words, the initial contact information is likely not valid contact information for two different users, and the confidence score for the primary contact information is reduced accordingly.

The embodiments disclosed above are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example network environment associated with a social-networking system.

FIG. 2 illustrates an example social graph.

FIG. 3 illustrates an example flow chart of a method for contacts confidence scoring.

FIG. 4 illustrates an example sequence diagram for contacts confidence scoring.

FIG. 5 illustrates an example computer system.

### DESCRIPTION OF EXAMPLE EMBODIMENTS

### System Overview

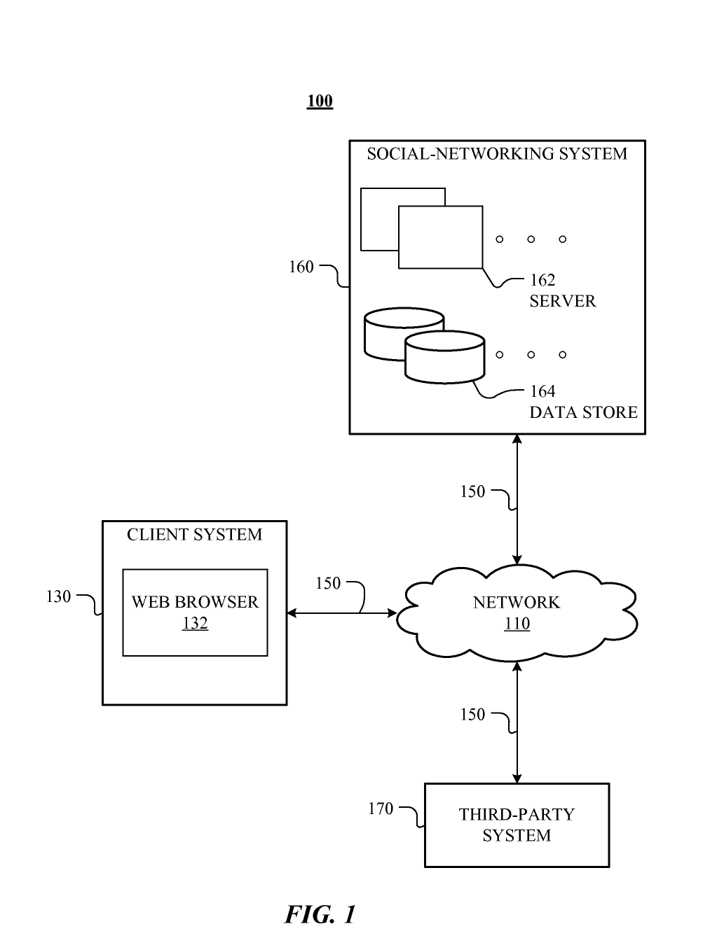

FIG. 1 illustrates an example network environment 100 associated with a social-networking system. Network environment 100 includes a client system 130, a social-networking system 160, and a third-party system 170 connected to each other by a network 110. Although FIG. 1 illustrates a particular arrangement of a client system 130, a social-networking system 160, a third-party system 170, and a network 110, this disclosure contemplates any suitable arrangement of a client system 130, a social-networking system 160, a third-party system 170, and a network 110. As an example and not by way of limitation, two or more of a client system 130, a social-networking system 160, and a third-party system 170 may be connected to each other directly, bypassing a network 110. As another example, two or more of a client system 130, a social-networking system 160, and a third-party system 170 may be physically or logically co-located with each other in whole or in part. Moreover, although FIG. 1 illustrates a particular number of client systems 130, social-networking systems 160, third-party systems 170, and networks 110, this disclosure contemplates any suitable number of client systems 130, social-networking systems 160, third-party systems 170, and networks 110. As an example and not by way of limitation, network environment 100 may include multiple client systems 130, social-networking systems 160, third-party systems 170, and networks 110.

This disclosure contemplates any suitable network 110. As an example and not by way of limitation, one or more portions of a network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. A network 110 may include one or more networks 110.

Links 150 may connect a client system 130, a social-networking system 160, and a third-party system 170 to a communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout a network environment 100. One or more first links 150 may differ in one or more respects from one or more second links 150.

In particular embodiments, a client system 130 may be an electronic device including hardware, software, or embedded logic components or a combination of two or more such components and capable of carrying out the appropriate functionalities implemented or supported by a client system 130. As an example and not by way of limitation, a client system 130 may include a computer system such as a desktop computer, notebook or laptop computer, netbook, a tablet computer, e-book reader, GPS device, camera, personal digital assistant (PDA), handheld electronic device, cellular telephone, smartphone, other suitable electronic device, or any suitable combination thereof. This disclosure contemplates any suitable client systems 130. A client system 130 may enable a network user at a client system 130 to access a network 110. A client system 130 may enable its user to communicate with other users at other client systems 130.

In particular embodiments, a client system 130 may include a web browser 132, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at a client system 130 may enter a Uniform Resource Locator (URL) or other address directing a web browser 132 to a particular server (such as server 162, or a server associated with a third-party system 170), and the web browser 132 may generate a Hyper Text Transfer Protocol (HTTP) request and communicate the HTTP request to server. The server may accept the HTTP request and communicate to a client system 130 one or more Hyper Text Markup Language (HTML) files responsive to the HTTP request. The client system 130 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate. More information on webpages may be found in U.S. patent application Ser. No. 11/856,202, filed 17 Sep. 2007, which is incorporated by reference.

In particular embodiments, the social-networking system 160 may be a network-addressable computing system that can host an online social network. The social-networking system 160 may generate, store, receive, and send social-networking data, such as, for example, user-profile data, concept-profile data, social-graph information, or other suitable data related to the online social network. The social-networking system 160 may be accessed by the other components of network environment 100 either directly or via a network 110. As an example and not by way of limitation, a client system 130 may access the social-networking system 160 using a web browser 132, or a native application associated with the social-networking system 160 (e.g., a mobile social-networking application, a messaging application, another suitable application, or any combination thereof) either directly or via a network 110. In particular embodiments, the social-networking system 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, the social-networking system 160 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable a client system 130, a social-networking system 160, or a third-party system 170 to manage, retrieve, modify, add, or delete, the information stored in data store 164.

In particular embodiments, the social-networking system 160 may store one or more social graphs in one or more data stores 164. In particular embodiments, a social graph may include multiple nodes—which may include multiple user nodes (each corresponding to a particular user) or multiple concept nodes (each corresponding to a particular concept)—and multiple edges connecting the nodes. The social-networking system 160 may provide users of the online social network the ability to communicate and interact with other users. In particular embodiments, users may join the online social network via the social-networking system 160 and then add connections (e.g., relationships) to a number of other users of the social-networking system 160 whom they want to be connected to. Herein, the term “friend” may refer to any other user of the social-networking system 160 with whom a user has formed a connection, association, or relationship via the social-networking system 160.

In particular embodiments, the social-networking system 160 may provide users with the ability to take actions on various types of items or objects, supported by the social-networking system 160. As an example and not by way of limitation, the items and objects may include groups or social networks to which users of the social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the social-networking system 160 or by an external system of a third-party system 170, which is separate from the social-networking system 160 and coupled to the social-networking system 160 via a network 110.

In particular embodiments, the social-networking system 160 may be capable of linking a variety of entities. As an example and not by way of limitation, the social-networking system 160 may enable users to interact with each other as well as receive content from third-party systems 170 or other entities, or to allow users to interact with these entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating the social-networking system 160. In particular embodiments, however, the social-networking system 160 and third-party systems 170 may operate in conjunction with each other to provide social-networking services to users of the social-networking system 160 or third-party systems 170. In this sense, the social-networking system 160 may provide a platform, or backbone, which other systems, such as third-party systems 170, may use to provide social-networking services and functionality to users across the Internet.

In particular embodiments, a third-party system 170 may include a third-party content object provider. A third-party content object provider may include one or more sources of content objects, which may be communicated to a client system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, the social-networking system 160 also includes user-generated content objects, which may enhance a user's interactions with the social-networking system 160. User-generated content may include anything a user can add, upload, send, or “post” to the social-networking system 160. As an example and not by way of limitation, a user communicates posts to the social-networking system 160 from a client system 130. Posts may include data such as status updates or other textual data, location information, photos, videos, links, music or other similar data or media. Content may also be added to the social-networking system 160 by a third-party through a “communication channel,” such as a newsfeed or stream.

In particular embodiments, the social-networking system 160 may include a variety of servers, sub-systems, programs, modules, logs, and data stores. In particular embodiments, the social-networking system 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The social-networking system 160 may also include suitable components such as network interfaces, security mechanisms, load balancers, failover servers, management-and-network-operations consoles, other suitable components, or any suitable combination thereof. In particular embodiments, the social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking the social-networking system 160 to one or more client systems 130 or one or more third-party systems 170 via a network 110. The web server may include a mail server or other messaging functionality for receiving and routing messages between the social-networking system 160 and one or more client systems 130. An API-request server may allow a third-party system 170 to access information from the social-networking system 160 by calling one or more APIs. An action logger may be used to receive communications from a web server about a user's actions on or off the social-networking system 160. In conjunction with the action log, a third-party-content-object log may be maintained of user exposures to third-party-content objects. A notification controller may provide information regarding content objects to a client system 130. Information may be pushed to a client system 130 as notifications, or information may be pulled from a client system 130 responsive to a request received from a client system 130. Authorization servers may be used to enforce one or more privacy settings of the users of the social-networking system 160. A privacy setting of a user determines how particular information associated with a user can be shared. The authorization server may allow users to opt in to or opt out of having their actions logged by the social-networking system 160 or shared with other systems (e.g., a third-party system 170), such as, for example, by setting appropriate privacy settings. Third-party-content-object stores may be used to store content objects received from third parties, such as a third-party system 170. Location stores may be used for storing location information received from client systems 130 associated with users. Advertisement-pricing modules may combine social information, the current time, location information, or other suitable information to provide relevant advertisements, in the form of notifications, to a user.

### Social Graphs

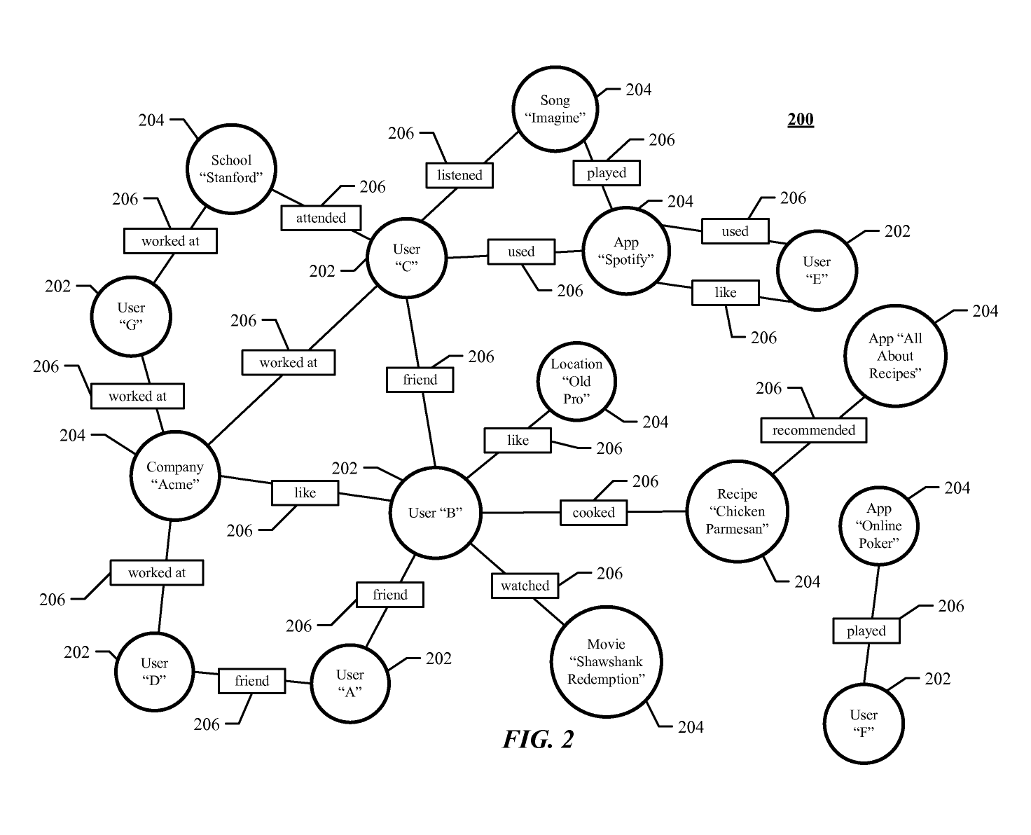

FIG. 2 illustrates an example social graph 200. In particular embodiments, the social-networking system 160 may store one or more social graphs 200 in one or more data stores. In particular embodiments, the social graph 200 may include multiple nodes—which may include multiple user nodes 202 or multiple concept nodes 204—and multiple edges 206 connecting the nodes. The example social graph 200 illustrated in FIG. 2 is shown, for didactic purposes, in a two-dimensional visual map representation. In particular embodiments, a social-networking system 160, a client system 130, or a third-party system 170 may access the social graph 200 and related social-graph information for suitable applications. The nodes and edges of the social graph 200 may be stored as data objects, for example, in a data store (such as a social-graph database). Such a data store may include one or more searchable or queryable indexes of nodes or edges of the social graph 200.

In particular embodiments, a user node 202 may correspond to a user of the social-networking system 160. As an example and not by way of limitation, a user may be an individual (human user), an entity (e.g., an enterprise, business, or third-party application), or a group (e.g., of individuals or entities) that interacts or communicates with or over the social-networking system 160. In particular embodiments, when a user registers for an account with the social-networking system 160, the social-networking system 160 may create a user node 202 corresponding to the user, and store the user node 202 in one or more data stores. Users and user nodes 202 described herein may, where appropriate, refer to registered users and user nodes 202 associated with registered users. In addition or as an alternative, users and user nodes 202 described herein may, where appropriate, refer to users that have not registered with the social-networking system 160. In particular embodiments, a user node 202 may be associated with information provided by a user or information gathered by various systems, including the social-networking system 160. As an example and not by way of limitation, a user may provide his or her name, profile picture, contact information, birth date, sex, marital status, family status, employment, education background, preferences, interests, or other demographic information. In particular embodiments, a user node 202 may be associated with one or more data objects corresponding to information associated with a user. In particular embodiments, a user node 202 may correspond to one or more webpages.

In particular embodiments, a concept node 204 may correspond to a concept. As an example and not by way of limitation, a concept may correspond to a place (such as, for example, a movie theater, restaurant, landmark, or city); a website (such as, for example, a website associated with the social-networking system 160 or a third-party website associated with a web-application server); an entity (such as, for example, a person, business, group, sports team, or celebrity); a resource (such as, for example, an audio file, video file, digital photo, text file, structured document, or application) which may be located within the social-networking system 160 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 204 may be associated with information of a concept provided by a user or information gathered by various systems, including the social-networking system 160. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 204 may be associated with one or more data objects corresponding to information associated with concept node 204. In particular embodiments, a concept node 204 may correspond to one or more webpages.

In particular embodiments, a node in the social graph 200 may represent or be represented by a webpage (which may be referred to as a “profile page”). Profile pages may be hosted by or accessible to the social-networking system 160. Profile pages may also be hosted on third-party websites associated with a third-party server 170. As an example and not by way of limitation, a profile page corresponding to a particular external webpage may be the particular external webpage and the profile page may correspond to a particular concept node 204. Profile pages may be viewable by all or a selected subset of other users. As an example and not by way of limitation, a user node 202 may have a corresponding user-profile page in which the corresponding user may add content, make declarations, or otherwise express himself or herself. As another example and not by way of limitation, a concept node 204 may have a corresponding concept-profile page in which one or more users may add content, make declarations, or express themselves, particularly in relation to the concept corresponding to concept node 204.

In particular embodiments, a concept node 204 may represent a third-party webpage or resource hosted by a third-party system 170. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client system 130 to send to the social-networking system 160 a message indicating the user's action. In response to the message, the social-networking system 160 may create an edge (e.g., a check-in-type edge) between a user node 202 corresponding to the user and a concept node 204 corresponding to the third-party webpage or resource and store edge 206 in one or more data stores.

In particular embodiments, a pair of nodes in the social graph 200 may be connected to each other by one or more edges 206. An edge 206 connecting a pair of nodes may represent a relationship between the pair of nodes. In particular embodiments, an edge 206 may include or represent one or more data objects or attributes corresponding to the relationship between a pair of nodes. As an example and not by way of limitation, a first user may indicate that a second user is a “friend” of the first user. In response to this indication, the social-networking system 160 may send a “friend request” to the second user. If the second user confirms the “friend request,” the social-networking system 160 may create an edge 206 connecting the first user's user node 202 to the second user's user node 202 in the social graph 200 and store edge 206 as social-graph information in one or more of data stores 164. In the example of FIG. 2, the social graph 200 includes an edge 206 indicating a friend relation between user nodes 202 of user “A” and user “B” and an edge indicating a friend relation between user nodes 202 of user “C” and user “B.” Although this disclosure describes or illustrates particular edges 206 with particular attributes connecting particular user nodes 202, this disclosure contemplates any suitable edges 206 with any suitable attributes connecting user nodes 202. As an example and not by way of limitation, an edge 206 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in the social graph 200 by one or more edges 206.

In particular embodiments, an edge 206 between a user node 202 and a concept node 204 may represent a particular action or activity performed by a user associated with user node 202 toward a concept associated with a concept node 204. As an example and not by way of limitation, as illustrated in FIG. 2, a user may “like,” “attended,” “played,” “listened,” “cooked,” “worked at,” or “watched” a concept, each of which may correspond to a edge type or subtype. A concept-profile page corresponding to a concept node 204 may include, for example, a selectable “check in” icon (such as, for example, a clickable “check in” icon) or a selectable “add to favorites” icon. Similarly, after a user clicks these icons, the social-networking system 160 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, the social-networking system 160 may create a “listened” edge 206 and a “used” edge (as illustrated in FIG. 2) between user nodes 202 corresponding to the user and concept nodes 204 corresponding to the song and application to indicate that the user listened to the song and used the application. Moreover, the social-networking system 160 may create a “played” edge 206 (as illustrated in FIG. 2) between concept nodes 204 corresponding to the song and the application to indicate that the particular song was played by the particular application. In this case, “played” edge 206 corresponds to an action performed by an external application (SPOTIFY) on an external audio file (the song “Imagine”). Although this disclosure describes particular edges 206 with particular attributes connecting user nodes 202 and concept nodes 204, this disclosure contemplates any suitable edges 206 with any suitable attributes connecting user nodes 202 and concept nodes 204. Moreover, although this disclosure describes edges between a user node 202 and a concept node 204 representing a single relationship, this disclosure contemplates edges between a user node 202 and a concept node 204 representing one or more relationships. As an example and not by way of limitation, an edge 206 may represent both that a user likes and has used at a particular concept. Alternatively, another edge 206 may represent each type of relationship (or multiples of a single relationship) between a user node 202 and a concept node 204 (as illustrated in FIG. 2 between user node 202 for user “E” and concept node 204 for “SPOTIFY”).

In particular embodiments, the social-networking system 160 may create an edge 206 between a user node 202 and a concept node 204 in the social graph 200. As an example and not by way of limitation, a user viewing a concept-profile page (such as, for example, by using a web browser or a special-purpose application hosted by the user's client system 130) may indicate that he or she likes the concept represented by the concept node 204 by clicking or selecting a “Like” icon, which may cause the user's client system 130 to send to the social-networking system 160 a message indicating the user's liking of the concept associated with the concept-profile page. In response to the message, the social-networking system 160 may create an edge 206 between user node 202 associated with the user and concept node 204, as illustrated by “like” edge 206 between the user and concept node 204. In particular embodiments, the social-networking system 160 may store an edge 206 in one or more data stores. In particular embodiments, an edge 206 may be automatically formed by the social-networking system 160 in response to a particular user action. As an example and not by way of limitation, if a first user uploads a picture, watches a movie, or listens to a song, an edge 206 may be formed between user node 202 corresponding to the first user and concept nodes 204 corresponding to those concepts. Although this disclosure describes forming particular edges 206 in particular manners, this disclosure contemplates forming any suitable edges 206 in any suitable manner.

### Confidence Scoring

In particular embodiments a confidence score is generated that assesses the likelihood that a user of a social-networking system is still associated with one or more instances of contact information. The confidence score can be generated or updated with reference to a variety of data sources accessible to a social-networking system, such as contact information lists updated by other users of the system. When the confidence score falls below a certain threshold level, actions can be triggered in order to validate or update the contact information. Aspects of the present disclosure may additionally describe using additional data, such as communications and location data, to assess a level of relatedness between users and weighting information received from those users at a higher level. Certain embodiments describe collecting device metadata and other data accessible via API calls to OS level mobile device interfaces to update or calculate confidence scores.

Social-networking systems often require one or more forms of valid contact information for each user in order to contact users in case of security violations, verify account status or activity, or communicate other critical information to users. For example, a new user of a social-networking system wishes to create an account. When activating the account, the user registers a mobile phone number with the social-networking system. A verification code may be sent to the mobile phone, allowing the user to complete registration by typing in the verification code at a registration screen. If suspicious login attempts or account activity is detected by the social-networking system, the system notifies the user via the verified phone number and prompts the user to take some action. This information may be also used for other functions such as password reset operations and activity notifications. For example, the social-networking system can use a two-step authentication procedure that requires a password and pin entry, where the pin is received on the mobile device the user registered his/her account with. As another example, if the user loses his/her social-networking system password, the contact information can be used to send a reset password or other account reset information to the user. Since the user verified possession of the device during the registration process, possession of the device (or another device configured to receive communications via the registered number), while not dispositive of user identity, provides evidence that the person resetting the account login information is the account holder.

However, primary contact information for a registered user can quickly become out of date, leaving the system with an ineffective mechanism for contacting registered users, and thus exposing vulnerabilities in the security of the system. For example, if a user registers an account using one phone number associated with a first SIM card and mobile device and replaces it with a second prepaid SIM card associated with a different phone number, the system may use the old phone number to attempt to notify the user that suspicious account activity, such as spam email being sent from his/her account, has been reported or detected. If this activity continues, the social networking system may shut down or block access to the account without the user ever receiving the notifications that were sent to his/her previous phone number. The user may thus have no quick or easy means of reactivating the account without access to the SIM card associated with the primary contact information because the system will have no way of authenticating whether the user is the spam generator (e.g., a spam-bot requesting a password reset) or the actual registered user.

While some examples and embodiments described herein may frequently refer to phone numbers as being a primary form of contact information, those of ordinary skill in the art will understand that contact information can include any type of contact information for communicating with a user, including, for example, email addresses, phone numbers, chat messenger screen names, postal addresses, and the like. Further, while the examples and embodiments described herein often deal with associating contact information with a user during a registration process of a user account, those of ordinary skill in the art will appreciate that contact information can be associated with a user, account, group, event, or any other social-graph node or construct at any time. This type of contact information may be referred to herein as “primary” contact information, “initial” contact information, a “primary” or “initial” form of contact information, or simply as contact information. However, there may be several instances of primary or initial contact information for any given user. Thus, the user may register an account using one form of primary contact information and register another form of primary contact information as he/she adds contact numbers, addresses, or accounts.

In certain embodiments, users of a social-networking system upload contact information from one or more external sources into the social-networking system. For example, a user can upload a contacts list from a mobile device into a social-networking system to provide a central interface for management and use of contact information. As another example, a user links his/her web-based email application account with a social-networking system to automatically import and update contact information between the two systems. More information on aggregating contacts may be found in U.S. patent application Ser. No. 13/791,591 which is incorporated by reference. More information on ranking contacts may be found in U.S. patent application Ser. No. 12/972,279 and U.S. patent application Ser. No. 14/503,884, each of which is incorporated by reference. This data may be continuously and/or automatically updated so that the social-networking system is provided with the most up to date version of the contact data. Such a technique may additionally reduce the amount of data transferred. For example, data redundancy and back-up procedures can be used to push only updates to contact data once a baseline set of data is received by the social-networking system. These updates may trigger an action to compare the updated data with the corresponding user's primary contact information.

Social-networking systems can provide mechanisms for associating contact information from a contact list, such as a contact list from a user's mobile device or email account, with other users of the social networking system. For example, a user, Steve, uploads contact information for a large number of contacts into a social-networking system. Steve has a contact named John Doe with a home phone, cell phone, and email address listed in Steve's contact list. When Steve uploads John Doe's contact information to the social-networking system, the social-networking system attempts to match the imported pieces of information to a user of the social-networking system. For example, the system may perform a reverse look-up using the home and mobile telephone numbers provided in Steve's upload for John Doe. This search may retrieve a user named John Doe, in which case the system can associate any unknown items of contact information from Steve's upload with the user John Doe. More information on matching user identifiers may be found in U.S. patent application Ser. No. 13/597,126 which is incorporated by reference.

In certain embodiments, users may manually associate contact information with a user of the social-networking system. For example, Steve's phone may have an interface that permits contact matching with a social-networking system. The contact list may pull items of information for manually or automatically matched contacts from the matched profile. In this example, Steve manually searches, via a contacts application, for John Doe, and manually matches the John Doe from his contacts with the John Doe from the social-networking system.

In particular embodiments, an application resident on a user's phone can access other applications, OS level processes, or embedded integrated circuits (e.g., contacts stored on a SIM card of a mobile device) via an API, and retrieve information, such as additional or alternative contact information for a particular user. For example, Steve also has an active messaging conversation with John Doe via one or more messaging applications, such as, for example, an SMS message conversation and a WHATSAPP group message conversation. Both of these example messaging protocols may require a phone number in order to send and receive messages. Accordingly, the application may match the John Doe contact by name or other supporting information with each messaging conversation and retrieve additional contact information for John Doe. In this example, John Doe has registered his WHATSAPP account with a secondary phone number that Steve was not previously aware of. The application thus gathers this secondary contact information and associates it with John Doe.

In particular embodiments a confidence score is generated based on collected contact information. The confidence score assesses the relative level of certainty with which a social networking system can associate an attribute, such as a primary form of contact information, with a user. The confidence score can be generated with reference to a variety of data sources available to a social-networking system, such as data sources provided via its users. For example, John Doe registers for a social-networking account by providing his cell phone number. As part of the user registration process, the cell phone number is verified via a two-step authentication process by sending John Doe a confirmation code via an SMS text message. Thus, the confidence score linking John Doe with the mobile phone number is quite high, such as, for example, 100%, due to the fact that the communication mechanism was just verified.

However, as time passes, other events can occur that call into question the validity of that contact information. For example, Steve's contact list application from his mobile phone pushes a contact list update to his social-networking system account that associates that mobile number (i.e., John Doe's old mobile number) with another user, Jane Doe. The system may detect these contact list updates and determine that the phone number, in fact, now belongs to a different user. The system receives updates from numerous users' contact lists that associate this new user, Jane Doe, with John Doe's primary contact phone number. The confidence score is adjusted accordingly to reflect this new information. The confidence score in this case may be 75%, since only a few users have updated contact information that associate John Doe's phone number with a different user. In another example, if Jane Doe uses the same number (i.e., John Doe's old number) to register her social-networking system account, the confidence score linking John Doe to his previously provided number may be significantly negatively impacted. For example, the confidence score may fall below 25%. A verification message may be sent to John Doe asking him/her to verify that the previously entered contact information is still correct.

In certain embodiments, contact information updates from users that are closely connected via a social-networking system are given more weight in the confidence score calculation. For example, John Doe provides a personal phone number as an update to his private account information. Friends of John Doe update their personal contact information lists, such as on mobile devices, with John Doe's personal phone number. These updates may occur before, during, or after John Doe updates his account information with the personal phone number. The system receives these contact list updates from John Doe's friends and uses this information to calculate a confidence score that assesses the relative likelihood that John Doe is actually associated with the phone number he provided. In this example, the confidence score may consider several factors, including one or more of the following factors: (1) that John Doe only recently updated his account information, (2) that, for example, 5 of John Doe's social-networking connections recently updated personal contact information for John Doe to include the number that John Doe provided, (3) that some other number of social-networking users have existing contact information for John Doe that includes the number that John Doe provided, (4) that one or more social-networking users are participating in active messaging threads via one or more messaging applications that are associated with the contact information that John Doe provided, and/or (5) that certain other users of the social-networking system that are not directly connected to John Doe have contact information with attributes that suggest that they are related to John Doe (e.g., other contact attributes such as same name, address, etc. that match John Does listed contact information attributes), and that this contact information matches John Doe's personal phone number.

In particular embodiments, the confidence score linking John Doe to the contact information he provided may also be calculated based on other indications that negatively impact the confidence score. For example, the confidence score may be based on the following additional or alternative factors: (1) that one or more social-networking system users recently updated their contact information for John Doe to include a phone number that is not the personal phone number that John Doe provided, (2) that one or more social-networking system users updated their contact information for John Doe to remove a phone number matching the phone number that John Doe provided, (3) that one or more social-networking system users updated their contact information for a different person, organization, or entity, other than John Doe, to include the personal phone number that John Doe provided, or (4) the period of time within which John Doe has updated his account information exceeds some threshold time period.

One or more of these, or other, factors can be used to calculate a confidence score that represents the probability that John Doe is still associated with the contact information he provided. Further the occurrence of one or more of these factors may more substantially affect the confidence score. For example, when several other users of a social-networking system update contact information for a different user (e.g., Jane Doe) to include the contact information that John Doe provided, the system may significantly reduce the confidence score associated with John Doe's provided contact information. In this example, the occurrence of repeated updates by different users reduces the risk that the update was made in error, which is more frequently the case in single-user updates. Further, these updates are made with respect to a single social-networking system user (i.e., Jane Doe), which increases the plausibility that Jane Doe recently added a line or otherwise acquired John Doe's old contact information and that John Doe is therefore no longer associated with that contact information. Thus, the confidence score is significantly reduced when this series of events occurs to reflect the low probability that John Doe is still associated with the contact information that he provided.

The examples described herein may refer to the confidence score as a percentage, such as 100%, 75%, or 25%. Those of ordinary skill in the art will understand that confidence scores can be expressed in any suitable metric or fashion, including alternative formats other than a percentage or number. For example, the confidence scoring system may use ratings, such as “highly confident,” “confident,” and “not confident,” though the complexity of the confidence score is often better expressed in a more complex metric.

Confidence scores are monitored to ensure that the primary contact information for each user is kept up to date. For example, while the confidence score for John Doe's primary mobile phone number is initially high, Jane Doe uploads an update to John Doe's contact information that includes a different mobile phone number for John Doe. The system recognizes that John Doe may have merely purchased an additional mobile line, or alternatively, that Jane Doe has made a mistake in entering John Doe's mobile phone number. Accordingly, since this evidence is relatively weak, the confidence score is lowered only slightly from 100% to 90%. A threshold for sending a first notification requesting confirmation of contact information is set at 60%. Thus, no confidence score thresholds are reached as a result of this one-off event. However, still using the above example, when Steve pushes an update to John Doe's contact information that does not include John Doe's primary mobile phone number, the confidence score is decreased even further. This update may be enough to push the confidence score below the 60% threshold, due to the fact that this is now the second user that has pushed such an update to the social-networking system. Steve's update validates Jane Doe's update and thus makes both more reliable indicators that John Doe has in fact gotten a new mobile phone number. Nevertheless, since it is still equally plausible that John Doe has merely added an additional mobile phone number and not eliminated his old mobile phone number, the confidence score is only adjusted to 55%. Continuing on with this example, yet another user, Tom Doe, uploads contact information to a social-networking system that associates a different user with John Doe's primary mobile number. Such an update may be some of the strongest evidence supporting the notion that John Doe is not associated with his primary mobile phone number anymore. Accordingly, the system may significantly reduce the confidence score after receiving such an update.

Those of ordinary skill in the art will understand the numerous ways that confidence scores can be calculated and adjusted, as well the various events that justify a reduction and/or increase in confidence scoring and the various threshold level configurations.

In certain embodiments, the underlying contact information, such as the actual phone numbers or addresses uploaded to or accessed by the system, are not used by the social-networking system for any purpose other than for comparison with other systems. For example, attributes of a contact graph, such as telephone numbers or email addresses, can be abstracted (e.g., hashed or otherwise anonymized) before further processing. As another example, only data regarding comparisons is utilized by the social-networking system. Thus, when contact information is imported for a user, only the data regarding a new or different number detected as being associated with that user is used by the social-networking system. Accordingly, the system may prompt the user to update the registered information.

A contacts graph can be constructed that includes an abstracted or hashed version of the imported contact information for each user. Contact graphs can be compared to other contact graphs and discrepancies in contact information can be used in formulating confidence scores. For example, a contact graph associated with Steve is created from his contacts that abstracts the phone number of each contact. The contact graph associated with Steve can then be compared to other users' contact graphs. The abstraction is used to detect discrepancies between nodes in the contact graph that correspond to a single user. For example, a hash algorithm is applied to each of Steve's contacts' phone numbers. The same or a different hash algorithm is applied to Jane Doe's contacts. When Steve and Jane Doe's contact graphs are compared, the social-networking system can detect that each user has different contact information listed for John Doe. However, the system may be unaware of what each user actually has listed as John Doe's contact information. Thus, using the hashed contact graph, the actual contact information for each contact is abstracted from the social-networking system.

Certain users may feel uneasy about contact information being collected by a system, even if only for use in aggregating and comparing with other user's updates. The hashed contact graph provides a configuration for social-networking systems to respect the privacy concerns of their users in order to increase trust in their networks, and thus increase the amount of social interaction occurring thereon. Accordingly, the teachings of the present disclosure provide for various methods of abstraction and aggregation of collected information before confidence score processing to these alleviate privacy concerns. Further, certain confidence score calculations or processing can be performed on client devices to prevent transmission of any contact information. Thus, not only do certain embodiments not retain any additional contact information, but these embodiments additionally avoid the appearance of retaining contact information by performing certain contact information processing operations, such as contact comparisons, on the client device.

The confidence scores can be monitored and events can be triggered when a confidence score falls below a certain threshold. Events can include sending a notification to a user, such as via a messaging application, email, social-networking interface (e.g., a popup message), or other notification mechanism. Events also include sending reminder emails that remind the user to update his/her contact information. For example, when the confidence score falls below a first threshold, such a reminder notification may be generated. More serious events can also be triggered that require user action, such as a prompt the next time the user logs in to the system that requires the user to update his/her contact information. For example, when the confidence score falls below a second threshold, this type of event can be triggered.

In certain embodiments, device metadata is utilized to suggest social networking interactions between users that are otherwise not connected via the social-networking system. For example, device metadata can track interactions with other users, such as frequently called phone numbers and text message communication participants. This information may be extracted through a mobile device operating system API, or other interface with a device service provider or carrier. Similarly, call-log information for a mobile device can be accessed via an OS level interface and is thus dependent on the underlying device. Further this information may be linked to contact information that is resident on the mobile device. The contact information may be associated with social-networking information for some contacts, or may not be associated with any social-networking information. In one example, a social-networking system application resident on the user's device determines device identifiers (e.g., phone numbers, email addresses) associated with users of the social-networking system from the retrieved device metadata. The application may suggest that the user connects with the social-networking users associated with those device identifiers. For example, the application suggests that the user invites another user associated with a telephone number that the user calls frequently to be friends in the social-network.

In particular embodiments, actions tied to confidence score fluctuations utilize additional device information in generating notifications or requests. For example, a mobile device with an embedded GPS system determines other social-networking users that the user is often physically close to. If the confidence score for the user's contact information falls below a threshold, the system can notify those users that are often physically close to the user to update their contact information for the user. Similarly, the user may update his/her own contact information (which would also impact the confidence score). The system may notify or prompt these near-by users of such an update. For example, Steve works with John Doe, and thus, spends a lot of time in the same office as him. John Doe's mobile device GPS detects that Steve is often close-by. When the confidence score for John Doe's mobile number falls below a threshold, the social-networking system may send a message to Steve that he should update his contact information for John Doe. Such an example provides an additional method of verification that John Doe is no longer associated with the primary contact information listed in the social-networking system.

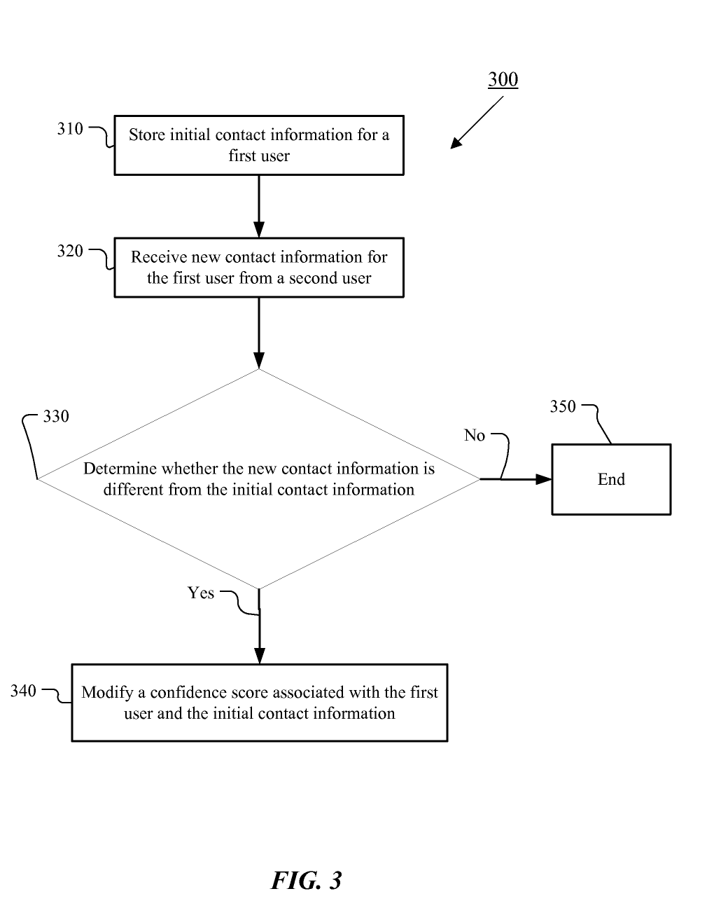

FIG. 3 illustrates an example flow chart 300 of a method for contacts confidence scoring. At step 310, initial contact information is stored for a first user. For example, John Doe registers with a social-networking system and enters his/her personal email address. As another example, John Doe merely updates existing social-networking contact information to provide updated contact information. In certain embodiments, the contact information provided is a primary form of contact information, such as contact information provided in a private account settings profile. In particular embodiments, the contact information provided is merely associated with John Doe, such as via an external system.

At step 320, new contact information for the first user is received from a second user. Continuing with the above example, Jane Doe updates a contact listing for John Doe within her GMAIL contacts list. Jane Doe updates John Doe's email address with a new email address. Accordingly, Jane Doe erases or deletes John Doe's old contact information from her contacts list and adds a new email address associated with John Doe.

In particular embodiments, Jane Doe can link her GMAIL contacts list with a contacts management platform or social-networking system such that updates or modifications to any GMAIL contacts are automatically pushed. In the above example, Jane Doe's update to John Doe's contact information may trigger an immediate or delayed push notification or push update to a contacts management platform or social-networking system.

At step 330, the new contact information for the first user is compared to the initial contact information. For example, a social-networking system receives updated contact information for John Doe. The updated contact information is associated with Jane Doe because it was received from her contacts list. This information can be compared to the contact information that John Doe provided to determine if there is a discrepancy. In certain embodiments, the social-networking system does not receive the actual contact information from the update, but instead merely receives a hash or other abstracted version of the contact information that is useful in comparing data. A comparison of the contact information can yield a determination that the updated contact information from Jane Doe is different from the contact information that John Doe provided. This type of comparison can be aggregated across all updates to contact information associated with John Doe, and a confidence score can be generated based on these and other related comparisons.

If the new contact information is different from the initial contact information, then a confidence score associated with the first user and the initial contact information is updated at step 340. For example, since Jane Doe deleted John Doe's provided email address and added a new email address for John Doe in her GMAIL contacts list, this is a strong indication that John Doe is no longer associated with his provided email address. Accordingly, the confidence score may be lowered, for example, from 300 to 260. In certain embodiments, if John Doe and Jane Doe are closely connected via a social-networking system, the score may be lowered even further due to the increased likelihood that Jane Doe is a more accurate barometer of John Doe's contact information that other users due to her close social-networking connectedness to John Doe. In this example, the score may be lowered to 200 due to such a close relationship. In another example where Jane Doe and John Doe are not closely related, the confidence score is only decreased to 280.

If the new contact information is the same as the initial contact information, however, then no further action may be needed (step 350). In certain embodiments, further actions may be taken based on the adjusted level of the confidence score, as described in more detail above. For example, a system may generate an email or other notification based on the confidence score falling below certain thresholds. One or more occurrences of the above described events may not have enough of an impact on the confidence score to cause it to fall below a threshold. Accordingly, no actions may be triggered as a result of such occurrences.

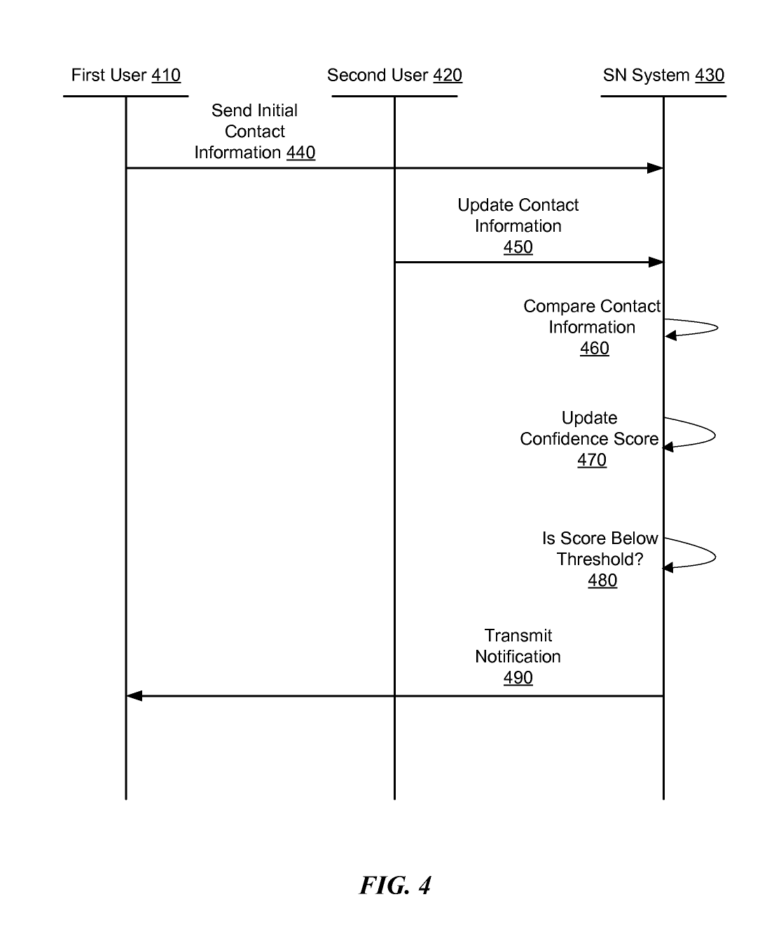

FIG. 4 illustrates an example sequence diagram for contacts confidence scoring. First user 410 sends initial contact information 440 to a social-networking system 430 (i.e., SN system 430). For example, a pizza restaurant registers with a social-networking system using valid contact information to increase its exposure to local residents of a community in which the restaurant is located. The business creates a website within the social-networking system and pays for advertisements via the social-networking system. Users of the social-networking system update their contact lists with contact information for the business. The confidence score for the restaurant is initially quite high due to this activity. However, the pizza restaurant notices that there is unmet demand for pizza in the community and sees an opportunity to expand within the area. Accordingly, the restaurant creates additional franchises within the same community, while maintaining the single social-networking system account associated with its brand.

Continuing on in FIG. 4, second user 420 updates contact information 450 for the first user 410. In the above example, a customer of the restaurant updates his/her mobile phone contact list to list the phone number of a new franchise that is more convenient to him/her. Such an update may occur in the contact lists of hundreds of customers who no longer have to travel across town to buy pizza. Some or all of these customers may push contact list updates to a social-networking system.

In response to these updates, SN system 430 compares 460 the initial contact information 440 with the updated contact information 450. A confidence score 470 is updated, and compared against one or more thresholds 480. Continuing on with the above example, this contact list updating activity may significantly reduce the confidence score, for example to 20, 10%, or “low probability” depending on the metric, or using any other metric for measuring confidence scores. Such a drastic reduction in the confidence score will most likely result in some sort of action being generated. In this case, the system may send an email (e.g., notification 490) to the restaurant using contact information provided in the registration process. In this example, the restaurant takes some sort of action to verify that the provided contact information is still valid. The system may recognize such a response as a validation that this new contact information (i.e., the contact information for the new franchise) is merely an additional form of contact information. Accordingly, further updates involving that contact information will not negatively impact the confidence score for the restaurant.

### Privacy

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page that identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 204 corresponding to a particular photo may have a privacy setting specifying that the photo may only be accessed by users tagged in the photo and their friends. In particular embodiments, privacy settings may allow users to opt in or opt out of having their actions logged by the social-networking system 160 or shared with other systems (e.g., a third-party system 170). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 170, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers 162 may be authorization/privacy servers for enforcing privacy settings. In response to a request from a user (or other entity) for a particular object stored in a data store 164, the social-networking system 160 may send a request to the data store 164 for the object. The request may identify the user associated with the request and may only be sent to the user (or a client system 130 of the user) if the authorization server determines that the user is authorized to access the object based on the privacy settings associated with the object. If the requesting user is not authorized to access the object, the authorization server may prevent the requested object from being retrieved from the data store 164, or may prevent the requested object from be sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

### Systems and Methods

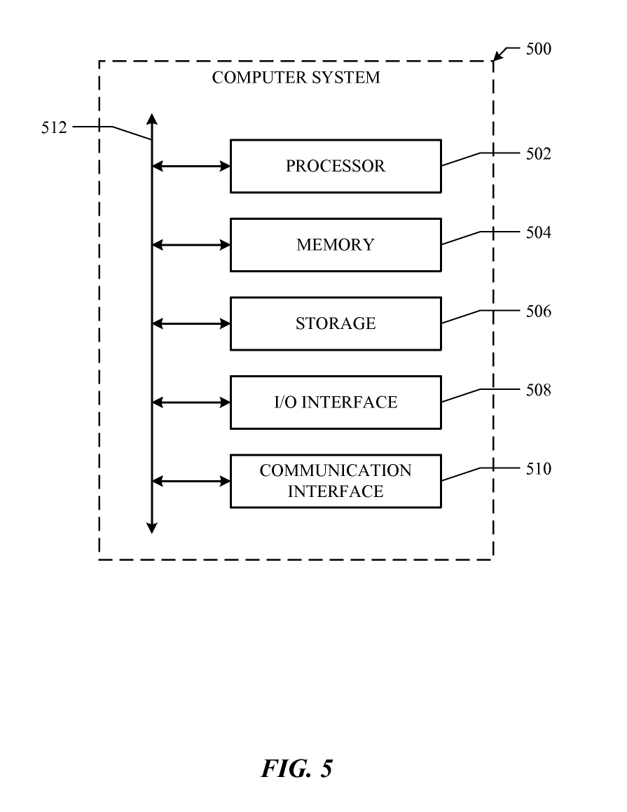

FIG. 5 illustrates an example computer system 500. In particular embodiments, one or more computer systems 500 perform one or more steps of one or more methods described or illustrated herein. In particular embodiments, one or more computer systems 500 provide functionality described or illustrated herein. In particular embodiments, software running on one or more computer systems 500 performs one or more steps of one or more methods described or illustrated herein or provides functionality described or illustrated herein. Particular embodiments include one or more portions of one or more computer systems 500. Herein, reference to a computer system may encompass a computing device, and vice versa, where appropriate. Moreover, reference to a computer system may encompass one or more computer systems, where appropriate.

This disclosure contemplates any suitable number of computer systems 500. This disclosure contemplates computer system 500 taking any suitable physical form. As example and not by way of limitation, computer system 500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 500 may include one or more computer systems 500; be unitary or distributed; span multiple locations; span multiple machines; span multiple data centers; or reside in a cloud, which may include one or more cloud components in one or more networks. Where appropriate, one or more computer systems 500 may perform without substantial spatial or temporal limitation one or more steps of one or more methods described or illustrated herein. As an example and not by way of limitation, one or more computer systems 500 may perform in real time or in batch mode one or more steps of one or more methods described or illustrated herein. One or more computer systems 500 may perform at different times or at different locations one or more steps of one or more methods described or illustrated herein, where appropriate.

In particular embodiments, computer system 500 includes a processor 502, memory 504, storage 506, an input/output (I/O) interface 508, a communication interface 510, and a bus 512. Although this disclosure describes and illustrates a particular computer system having a particular number of particular components in a particular arrangement, this disclosure contemplates any suitable computer system having any suitable number of any suitable components in any suitable arrangement.

In particular embodiments, processor 502 includes hardware for executing instructions, such as those making up a computer program. As an example and not by way of limitation, to execute instructions, processor 502 may retrieve (or fetch) the instructions from an internal register, an internal cache, memory 504, or storage 506; decode and execute them; and then write one or more results to an internal register, an internal cache, memory 504, or storage 506. In particular embodiments, processor 502 may include one or more internal caches for data, instructions, or addresses. This disclosure contemplates processor 502 including any suitable number of any suitable internal caches, where appropriate. As an example and not by way of limitation, processor 502 may include one or more instruction caches, one or more data caches, and one or more translation lookaside buffers (TLBs). Instructions in the instruction caches may be copies of instructions in memory 504 or storage 506, and the instruction caches may speed up retrieval of those instructions by processor 502. Data in the data caches may be copies of data in memory 504 or storage 506 for instructions executing at processor 502 to operate on; the results of previous instructions executed at processor 502 for access by subsequent instructions executing at processor 502 or for writing to memory 504 or storage 506; or other suitable data. The data caches may speed up read or write operations by processor 502. The TLBs may speed up virtual-address translation for processor 502. In particular embodiments, processor 502 may include one or more internal registers for data, instructions, or addresses. This disclosure contemplates processor 502 including any suitable number of any suitable internal registers, where appropriate. Where appropriate, processor 502 may include one or more arithmetic logic units (ALUs); be a multi-core processor; or include one or more processors 502. Although this disclosure describes and illustrates a particular processor, this disclosure contemplates any suitable processor.

In particular embodiments, memory 504 includes main memory for storing instructions for processor 502 to execute or data for processor 502 to operate on. As an example and not by way of limitation, computer system 500 may load instructions from storage 506 or another source (such as, for example, another computer system 500) to memory 504. Processor 502 may then load the instructions from memory 504 to an internal register or internal cache. To execute the instructions, processor 502 may retrieve the instructions from the internal register or internal cache and decode them. During or after execution of the instructions, processor 502 may write one or more results (which may be intermediate or final results) to the internal register or internal cache. Processor 502 may then write one or more of those results to memory 504. In particular embodiments, processor 502 executes only instructions in one or more internal registers or internal caches or in memory 504 (as opposed to storage 506 or elsewhere) and operates only on data in one or more internal registers or internal caches or in memory 504 (as opposed to storage 506 or elsewhere). One or more memory buses (which may each include an address bus and a data bus) may couple processor 502 to memory 504. Bus 512 may include one or more memory buses, as described below. In particular embodiments, one or more memory management units (MMUs) reside between processor 502 and memory 504 and facilitate accesses to memory 504 requested by processor 502. In particular embodiments, memory 504 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 504 may include one or more memories 504, where appropriate. Although this disclosure describes and illustrates particular memory, this disclosure contemplates any suitable memory.

In particular embodiments, storage 506 includes mass storage for data or instructions. As an example and not by way of limitation, storage 506 may include a hard disk drive (HDD), a floppy disk drive, flash memory, an optical disc, a magneto-optical disc, magnetic tape, or a Universal Serial Bus (USB) drive or a combination of two or more of these. Storage 506 may include removable or non-removable (or fixed) media, where appropriate. Storage 506 may be internal or external to computer system 500, where appropriate. In particular embodiments, storage 506 is non-volatile, solid-state memory. In particular embodiments, storage 506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 506 taking any suitable physical form. Storage 506 may include one or more storage control units facilitating communication between processor 502 and storage 506, where appropriate. Where appropriate, storage 506 may include one or more storages 506. Although this disclosure describes and illustrates particular storage, this disclosure contemplates any suitable storage.

In particular embodiments, I/O interface 508 includes hardware, software, or both, providing one or more interfaces for communication between computer system 500 and one or more I/O devices. Computer system 500 may include one or more of these I/O devices, where appropriate. One or more of these I/O devices may enable communication between a person and computer system 500. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 508 for them. Where appropriate, I/O interface 508 may include one or more device or software drivers enabling processor 502 to drive one or more of these I/O devices. I/O interface 508 may include one or more I/O interfaces 508, where appropriate. Although this disclosure describes and illustrates a particular I/O interface, this disclosure contemplates any suitable I/O interface.

In particular embodiments, communication interface 510 includes hardware, software, or both providing one or more interfaces for communication (such as, for example, packet-based communication) between computer system 500 and one or more other computer systems 500 or one or more networks. As an example and not by way of limitation, communication interface 510 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 510 for it. As an example and not by way of limitation, computer system 500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 500 may include any suitable communication interface 510 for any of these networks, where appropriate. Communication interface 510 may include one or more communication interfaces 510, where appropriate. Although this disclosure describes and illustrates a particular communication interface, this disclosure contemplates any suitable communication interface.

In particular embodiments, bus 512 includes hardware, software, or both coupling components of computer system 500 to each other. As an example and not by way of limitation, bus 512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 512 may include one or more buses 512, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

### Miscellaneous

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising:
by one or more processors, storing, in a profile of a first user of a social-networking system, initial contact information for the first user;
by the one or more processors, receiving, from a second user of the social-networking system, new contact information for the first user;
by the one or more processors, determining whether the new contact information for the first user is different than the initial contact information;
by the one or more processors, determining, based in part on whether the new contact information is different than the initial contact information, a confidence score for the initial contact information, the confidence score assessing a relative level of certainty with which the particular user is still associated with the initial contact information.

2. The method of claim 1, further comprising:
determining that the confidence score has fallen below a threshold level; and
sending, to a device associated with the first user, a request to update contact information in the user's profile.

3. The method of claim 1, wherein the initial contact information is received during an account registration process for the first user.

4. The method of claim 3, further comprising:
in response to receiving the initial contact information during the account registration process, determining that the confidence score for the initial contact information is a first value; and
in response to determining that the new contact information is different than the initial contact information, determining that the confidence score for the initial contact information is a second value, lower than the first value.

5. The method of claim 4, further comprising:
receiving the new contact information for the first user from a third user of the social-networking system; and
determining that the confidence score for the initial contact information is a third value, lower than the second value.

6. The method of claim 1, wherein the at least one data item associated with the first user is received from a contacts list of a device associated with one of the second user.

7. The method of claim 1, further comprising:
determining that the confidence score has fallen below a threshold level; and
sending, to a device associated with the initial contact information for the first user, a request to verify contact information in the user's profile.

8. The method of claim 1, further comprising:
receiving location data for the second user and the first user;
determining that the second user and the first user are in close proximity to one another; and
sending, to a device associated with the second user, a request to update contact information for the first user.

9. The method of claim 1, further comprising:
receiving, from a third user of the social-networking system, information indicating that the initial contact information is associated with a fourth user of the social-networking system; and
reducing the confidence score based on the information.

10. The method of claim 1, further comprising:
receiving, from a third user of the social-networking system, information indicating that the first user and the third user communicate with each other frequently;
determining that the confidence score for the initial contact information has fallen below a threshold level; and
notifying the third user that the initial contact information for the first user has likely changed.

11. One or more computer-readable non-transitory storage media embodying software that is operable when executed to:
store, in a profile of a first user of a social-networking system, initial contact information for the first user;
receive, from a second user of the social-networking system, new contact information for the first user;
determine whether the new contact information for the first user is different than the initial contact information;
determine, based in part on whether the new contact information is different than the initial contact information, a confidence score for the initial contact information, the confidence score assessing a relative level of certainty with which the particular user is still associated with the initial contact information.

12. The media of claim 11, the software being further operable when executed to:
determine that the confidence score has fallen below a threshold level; and
send, to a device associated with the first user, a request to update contact information in the user's profile.

13. The media of claim 11, wherein the initial contact information is received during an account registration process for the first user.

14. The media of claim 13, the software being further operable when executed to:
in response to receiving the initial contact information during the account registration process, determine that the confidence score for the initial contact information is a first value; and
in response to determining that the new contact information is different than the initial contact information, determine that the confidence score for the initial contact information is a second value, lower than the first value.

15. The media of claim 14, the software being further operable when executed to:
receive the new contact information for the first user from a third user of the social-networking system; and
determine that the confidence score for the initial contact information is a third value, lower than the second value.

16. The media of claim 11, wherein the at least one data item associated with the first user is received from a contacts list of a device associated with one of the second user.

17. The media of claim 11, the software being further operable when executed to:
determine that the confidence score has fallen below a threshold level; and
send, to a device associated with the initial contact information for the first user, a request to verify contact information in the user's profile.

18. The media of claim 11, the software being further operable when executed to:
receive location data for the second user and the first user;
determine that the second user and the first user are in close proximity to one another; and
send, to a device associated with the second user, a request to update contact information for the first user.

19. The media of claim 11, the software being further operable when executed to:
receive, from a third user of the social-networking system, information indicating that the initial contact information is associated with a fourth user of the social-networking system; and
reduce the confidence score based on the information.

20. A system comprising: one or more processors; and a non-transitory memory coupled to the processors comprising instructions executable by the processors, the processors operable when executing the instructions to:
store, in a profile of a first user of a social-networking system, initial contact information for the first user;
receive, from a second user of the social-networking system, new contact information for the first user;
determine whether the new contact information for the first user is different than the initial contact information;
determine, based in part on whether the new contact information is different than the initial contact information, a confidence score for the initial contact information, the confidence score assessing a relative level of certainty with which the particular user is still associated with the initial contact information.
